(19) United States
(12) Patent Application Publication
(10) Pub. No.: US 2016/0196789 A1
(43) Pub. Date: Jul. 7, 2016

(54) LIQUID CRYSTAL DISPLAY DEVICE AND DRIVING METHOD THEREFOR

(71) Applicant: SHARP KABUSHIKI KAISHA, Osaka-shi, Osaka (JP)

(72) Inventors: Tatsuhiko SUYAMA, Osaka-shi (JP); Noriyuki TANAKA, Osaka-shi (JP); Takuya SONE, Osaka-shi (JP); Norio OHMURA, Osaka-shi (JP); Kentaroh UEMURA, Osaka-shi (JP); Kouji KUMADA, Osaka-shi (JP)

(73) Assignee: Sharp Kabushiki Kaisha, Osaka-shi, Osaka (JP)

(21) Appl. No.: 14/653,348

(22) PCT Filed: Dec. 20, 2013
(86) PCT No.: PCT/JP2013/084213

§ 371 Date: Jun. 18, 2015

(30) Foreign Application Priority Data
Dec. 27, 2012 (JP) 2012-284218

(51) Int. Cl. G09G 3/36

(52) U.S. Cl. CPC G09G 3/3614; G09G 3/3688; G09G 3/3677; G09G 2300/0426; G09G 2320/0204; G09G 2330/021; G09G 2310/08

(57) ABSTRACT

There is provided a liquid crystal display device which is capable of reducing power consumption while preventing liquid crystal deterioration.

The liquid crystal display device performs an intermission driving. The liquid crystal display device includes a polarity indication section, which controls a driving section included in the liquid crystal display device so that the data voltages to be written to the pixel formation portions in a first refreshing frame included in the drive period have a same polarity as of the data voltages written to the pixel formation portions in the refreshing frame immediately preceding the first refreshing frame and that the data voltage polarity is inverted for each refreshing frame during the drive period, if the drive period includes an even number of the refreshing frames.

### TECHNICAL FIELD

The present invention relates to liquid crystal display devices, and more particularly to a liquid crystal display device which performs intermission driving, and to a method of driving the same.

### BACKGROUND ART

Rigorous efforts are underway in recent years for development of light and compact electronic devices. Such electronic devices require liquid crystal display devices of low power consumption. For reduced power consumption of liquid crystal display devices, intermission driving is proposed as a promising technique. A liquid crystal display device which performs intermission driving alternately repeats a drive period in which scanning lines are scanned and data voltages are written for refreshing an image, and an intermission period in which all the scanning lines are brought into a de-selected state for stopping the writing of data voltages. In the intermission period, a voltage applied to a liquid crystal layer in each pixel formation portion (hereinafter called “liquid crystal application voltage”) during an immediately preceding drive period is maintained, so the displayed image is maintained. Hence, during the intermission period, operation of a gate driver and/or of a source driver can be stopped and therefore it is possible to reduce power consumption. Patent Literature 1, for example, discloses a liquid crystal display device which performs such an intermission driving as described above.

Generally in liquid crystal display devices, polarity inversion drive is utilized for reduced DC component in the liquid crystal application voltage. Specifically, for each pixel, the number of frames in which the liquid crystal application voltage has a positive polarity (hereinafter called “positive-polarity frame”) and the number of frames in which the liquid crystal application voltage has a negative polarity (hereinafter called “negative-polarity frame”) are balanced with each other, whereby polarity imbalance in the liquid crystal application voltage is eliminated. This reduces the DC component in the liquid crystal application voltage, and thereby prevents deterioration of the liquid crystal.

### LIST OF REFERENCES

### Patent Literature

Patent Literature 1: Japanese Unexamined Patent Application Publication No. 2001-312253

### SUMMARY OF THE INVENTION

### Problems to be Solved by the Invention

In a liquid crystal display device which performs an intermission driving, a liquid crystal application voltage during an intermission period has the polarity of the data voltage written to the pixel formation portion in the immediately preceding drive period. This leads to a problem, depending on how the data voltage is written during the drive period, that one of the positive-polarity frame and the negative-polarity frame becomes greater in number while the other becomes smaller in number, resulting in polarity imbalance in the liquid crystal application voltage. Therefore, it becomes difficult to prevent deterioration of the liquid crystal.

It is therefore an object of the present invention to provide a liquid crystal display device which is capable of reducing power consumption while preventing the deterioration of the liquid crystal, and a driving method for the liquid crystal display device.

### Solutions to the Problem

A first aspect of the present invention provides a liquid crystal display device including a plurality of pixel formation portions and performing an intermission driving of alternately repeating a drive period for writing data voltages based on an externally supplied image signal to the pixel formation portions and an intermission period for stopping writing of the data voltages to the pixel formation portions.

This device further includes:

a driving section configured to write the data voltages to the pixel formation portions, and

a display controller configured to control the driving section,

the display controller including:

a frame setting section configured to control the driving section so that the drive period includes one or more refreshing frames, which are frames for writing the data voltages to the pixel formation portions, and the intermission period includes at least one non-refreshing frame, which is a frame for stopping writing of the data voltages; and

a polarity indication section configured to control the driving section so that the data voltages to be written to the pixel formation portions in a first refreshing frame included in the drive period have a same polarity as of the data voltages written to the pixel formation portions in a refreshing frame immediately preceding the first refreshing frame and that the data voltage polarity is inverted for each refreshing frame during the drive period, if the drive period includes an even number of the refreshing frames.

A second aspect of the present invention provides the first aspect of the present invention, and in this arrangement:

the polarity indication section controls the driving section so that the data voltages to be written to the pixel formation portions in each refreshing frame included in the drive period have a different polarity from that of the data voltages written to the pixel formation portions in a refreshing frame immediately preceding each relevant refreshing frame, if the drive period includes an odd number of the refreshing frames.

A third aspect of the present invention provides the first aspect of the present invention, and in this arrangement:

the polarity indication section controls the driving section so that the data voltages to be written to the pixel formation portions in a first refreshing frame included in the drive period have a same polarity as of the data voltages written to the pixel formation portions in a refreshing frame immediately preceding the first refreshing frame and that the data voltage polarity is inverted for each refreshing frame during the drive period, if the drive period set for a time of image updating includes an even number of the refreshing frames.

A fourth aspect of the present invention provides the first aspect of the present invention, and in this arrangement:

the liquid crystal display device further includes data lines and scanning lines connected to the pixel formation portions and the driving section, wherein

each pixel formation portion includes:

a pixel electrode to be supplied with the data voltage; and

a thin film transistor having a control terminal connected to one of the scanning lines, a first conduction terminal connected to one of the data lines, a second conduction terminal connected to the pixel electrode, and a channel layer formed of an oxide semiconductor.

A fifth aspect of the present invention provides the fourth aspect of the present invention, and in this arrangement:

the oxide semiconductor contains indium, gallium, zinc and oxygen as primary components.

A sixth aspect of the present invention provides a driving method for a liquid crystal display device including a plurality of pixel formation portions and performing an intermission driving of alternately repeating a drive period for writing data voltages based on an externally supplied image signal to the pixel formation portions and an intermission period for stopping writing of the data voltages to the pixel formation portions.

This method includes:

a step of controlling the driving so that the drive period includes one or more refreshing frames, which are frames for writing the data voltages to the pixel formation portions, and that the intermission period includes at least one non-refreshing frame, which is a frame for stopping writing of the data voltages; and

a step of controlling polarity of the data voltages so that the data voltages to be written to the pixel formation portions in a first refreshing frame included in the drive period have a same polarity as of the data voltages written to the pixel formation portions in a refreshing frame immediately preceding the first refreshing frame and that the data voltage polarity is inverted for each refreshing frame during the drive period, if the drive period includes an even number of the refreshing frames.

### Advantages of the Invention

According to the first aspect of the present invention, when the drive period includes an even number of refreshing frames, data voltages to be written to the pixel formation portions in the first refreshing frame included in the drive period have the same polarity as of the data voltages written to the pixel formation portions in the immediately preceding refreshing frame. This ensures that even if data voltage polarity is inverted for each refreshing frame during the drive period, two consecutive intermission periods which sandwich the drive period have different liquid crystal application voltage polarities from each other. The arrangement ensures that the number of positive-polarity frames and the number of negative-polarity frames become approximately equal to each other, thereby removing bias in the liquid crystal application voltage polarity. Therefore, it is possible to reduce power consumption while preventing deterioration of the liquid crystal.

According to the second aspect of the present invention, when the drive period includes an odd number of refreshing frames, two consecutive intermission periods which sandwich the drive period have different polarities from each other in their respective constituent frames. The arrangement ensures that the number of positive-polarity frames and the number of negative-polarity frames become approximately equal to each other, thereby removing bias in the liquid crystal application voltage polarity. Therefore, it is possible to reduce power consumption while preventing deterioration of the liquid crystal also in the case where the drive period includes an odd number of refreshing frames.

According to the third aspect of the present embodiment, an image updating is accompanied by a plurality (even number) of refreshing frames. This prevents the displayed image from persisting as a residual image.

According to the fourth aspect of the present invention, a thin film transistor is used which has a channel layer formed of an oxide semiconductor. Since this thin film transistor has a very small off-leak current, the liquid crystal application voltage does not change significantly while the TFT is turned OFF. This makes it possible to make the intermission period longer for further decrease in power consumption.

According to the fifth aspect of the present invention, the thin film transistor has its channel layer formed of an oxide semiconductor containing indium, gallium, zinc and oxygen as primary components. This offers the same advantages as provided by the fourth aspect of the present invention.

According to the sixth aspect of the present invention, the same advantages as offered by the first aspect of the present invention are provided in a driving method of the liquid crystal display device.

### BRIEF DESCRIPTION OF DRAWINGS

FIG. 1 is a timing chart for describing a first example of intermission driving in the basic consideration under the present invention.

FIG. 2 is a timing chart for describing a second example of intermission driving in the basic consideration under the present invention.

FIG. 3 is a block diagram for describing a configuration of a liquid crystal display device according to an embodiment of the present invention.

FIG. 4 is a timing chart which shows control details in each frame in the embodiment, for cases where each drive period has an even number of refreshing frames.

FIG. 5 is a timing chart for comparison between the intermission driving according to the embodiment for cases where each drive period has an even number of refreshing frames and the second example of intermission driving in the basic consideration.

FIG. 6 is a timing chart which shows control details in each frame in the embodiment, for cases where each drive period has an odd number of refreshing frames.

FIG. 7 is a timing chart which shows control details in each frame in a first variation of the embodiment.

FIG. 8 is a timing chart which shows control details in each frame in a second variation of the embodiment.

FIG. 9 is a timing chart which shows control details in each frame in a third variation of the embodiment.

FIG. 10 is a timing chart which shows control details in each frame in a fourth variation of the embodiment.

### DESCRIPTION OF EMBODIMENTS

Hereinafter, a frame for writing data voltages to pixel formation portions will be called “refreshing frame”, whereas a frame for stopping the data voltage writing will be called “non-refreshing frame”. Also, “pixel voltage polarity” to be used when referring to timing charts in the following description refers to a voltage polarity in a single specific pixel formation portion. More specifically, in a refreshing frame, the term refers to a polarity of a data voltage in the pixel formation portion and a polarity of the liquid crystal application voltage, whereas in a non-refreshing frame, the term refers to a polarity of a liquid crystal application voltage in the pixel formation portion. Since the data voltage and the liquid crystal application voltage have the same polarity in the refreshing frame, there may be cases where description is made only for one of the data voltage polarity and the liquid crystal application voltage polarity, without covering the other.

### 0. Basic Consideration

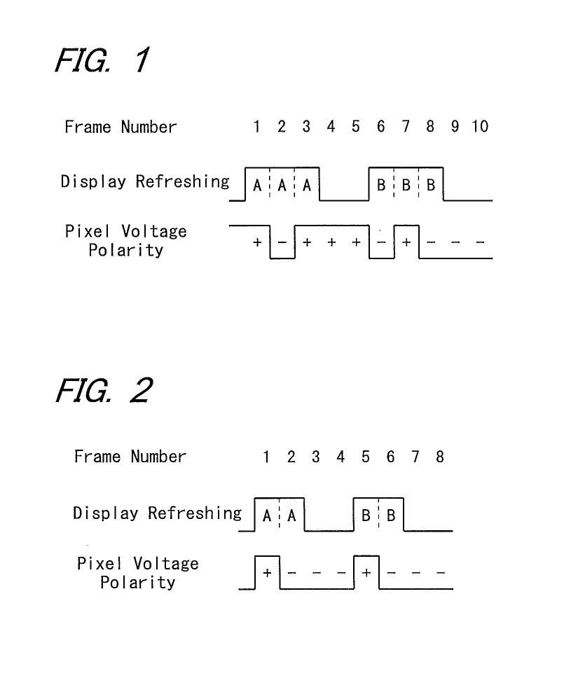

Before describing embodiments of the present invention, a basic consideration which was made by the inventor of the present invention in efforts of achieving the above-mentioned object will be covered. FIG. 1 is a timing chart for describing a first example of intermission driving in the basic consideration under the present invention. A liquid crystal display device which performs an intermission driving according to the basic consideration under the present invention sets a drive period and an intermission period alternately to each other based on an image signal and a command supplied from an external host. The drive period and the intermission period are set using a frame as a unit. In the example shown in FIG. 1, each drive period is made of three refreshing frames. The period constituted by the first through the third frames, and the period constituted by the sixth through the eighth frames each represent a drive period. The drive period constituted by the first through the third frames is for performing a refreshing by using a data voltage which represents an image “A”, whereas the drive period constituted by the sixth through the eighth frames is for performing a refreshing by using a data voltage which represents an image “B”. It should be noted here that the drive period which is made of the first through the third frames and the drive period which is made of the sixth through the eighth frames may use data voltages which represent the same image for their respective refreshing operations. Each intermission period is made of two non-refreshing frames. The period constituted by the fourth and fifth frames, and the period constituted by the ninth and tenth frames each represent an intermission period.

In a polarity inversion drive generally utilized in conventional liquid crystal display devices, data voltage polarity is inverted for every refreshing frame. This is also followed in the example in FIG. 1, so data voltage polarity is inverted for every refreshing frame. It is assumed that in a refreshing frame immediately preceding the first frame, a negative-polarity (−) data voltage is used for refreshing. In the first frame, data voltage polarity is inverted from the polarity used in the immediately preceding refreshing frame; i.e., a refreshing is performed by using a positive-polarity (+) data voltage. Likewise, data voltage polarity is inverted also in the second and the third frames in the same manner; i.e., a refreshing is performed by using a negative-polarity data voltage and then by using a positive-polarity data voltage. In the fourth and the fifth frames, the same positive-polarity liquid crystal application voltage as in the third frame is maintained. In the sixth frame, data voltage polarity is inverted from the one used in the third frame; i.e., a refreshing is performed by using a negative-polarity data voltage. Likewise, data voltage polarity is inverted also in the seventh and the eighth frames; i.e., a refreshing is performed by using a positive-polarity data voltage and then by using a negative-polarity data voltage. In the ninth and the tenth frames, the same negative-polarity liquid crystal application voltage as in the eighth frame is maintained.

As described, in the example in FIG. 1, the number of positive-polarity frames and the number of negative-polarity frames are both five in the first through the tenth frames. In other words, the number of positive-polarity frames and the number of negative-polarity frames are balanced with each other. This makes liquid crystal application voltage polarity bias relatively small. This reduces DC component in the liquid crystal application voltage, and thereby prevents deterioration of the liquid crystal. Note that this is true not only in the case as shown in FIG. 1 where each drive period includes three refreshing frames but also in all cases where each drive period includes an odd number of refreshing frames other than three, and also in cases where each drive period includes an odd number of refreshing frames and one or more non-refreshing frames.

FIG. 2 is a timing chart for describing a second example of the intermission driving in the basic consideration under the present invention. In the example shown in FIG. 2, each drive period is made of two refreshing frames. The period constituted by the first and the second frames, and the period constituted by the fifth and the sixth frames each represent a drive period. The drive period constituted by the first and the second frames is for performing a refreshing by using a data voltage which represents an image “A”, whereas the drive period constituted by the fifth and the sixth frames is for performing a refreshing by using a data voltage which represents an image “B”. It should be noted here that the drive period which is made of the first and the second frames and the drive period which is made of the fifth and the sixth frames may use data voltages which represent the same image for their respective refreshing operations. Each intermission period is made of two non-refreshing frames. The period constituted by the third and the fourth frames, and the period constituted by the seventh and the eighth frames each represent an intermission period.

Like in the example in FIG. 1, data voltage polarity is inverted for every refreshing frame in the example in FIG. 2. It is assumed that in a refreshing frame immediately preceding the first frame, a negative-polarity data voltage is used for refreshing. In the first frame, data voltage polarity is inverted from the one used in the immediately preceding refreshing frame; i.e., a refreshing is performed by using a positive-polarity data voltage. In the second frame, data voltage polarity is inverted also; i.e., a refreshing is performed by using a negative-polarity data voltage. In the third, and the fourth frames, the same negative-polarity liquid crystal application voltage as in the second frame is maintained. In the fifth frame, data voltage polarity is inverted from the one used in the second frame; i.e., a refreshing is performed by using a positive-polarity data voltage. In the sixth frame, data voltage polarity is inverted again; i.e., a refreshing is performed by using a negative-polarity data voltage. In the seventh and the eighth frames, the same negative-polarity liquid crystal application voltage as in the sixth frame is maintained.

As described, according to the example in FIG. 2, the number of positive-polarity frames is two in the first through the eighth frame, whereas the number of negative-polarity frames is six. In other words, the number of positive-polarity frames and the number of negative-polarity frames are not balanced with each other. This makes liquid crystal application voltage polarity bias relatively large. This increases DC component in the liquid crystal application voltage, which makes it impossible to prevent deterioration of the liquid crystal. Note that this is true not only in the case as shown in FIG. 2 where each drive period includes two refreshing frames but also in all cases where each drive period includes four or a greater even number of refreshing frames, and also in cases where each drive period includes an even number of refreshing frames and one or more non-refreshing frames.

It is understood from the above, that if the drive period includes an even number of refreshing frames, liquid crystal application voltage polarity is the same in two consecutive intermission periods sandwiching the drive period even if data voltage polarity is inverted for every refreshing frame during the drive period. In other words, the number of positive-polarity frames and the number of negative-polarity frames are not balanced with each other, resulting in a relatively large liquid crystal application voltage polarity bias. This increases DC component in the liquid crystal application voltage, which makes it impossible to prevent deterioration of the liquid crystal.

### 1. Embodiment

Hereinafter, description will cover embodiments of the present invention, which are implemented by the inventor of the present invention on the basis of the basic consideration, with reference to the attached drawings. It should be noted here that description may not be provided when appropriate, for portions of intermission driving if they are identical with those already covered in the basic consideration.

<1.1 Liquid Crystal Display Device>

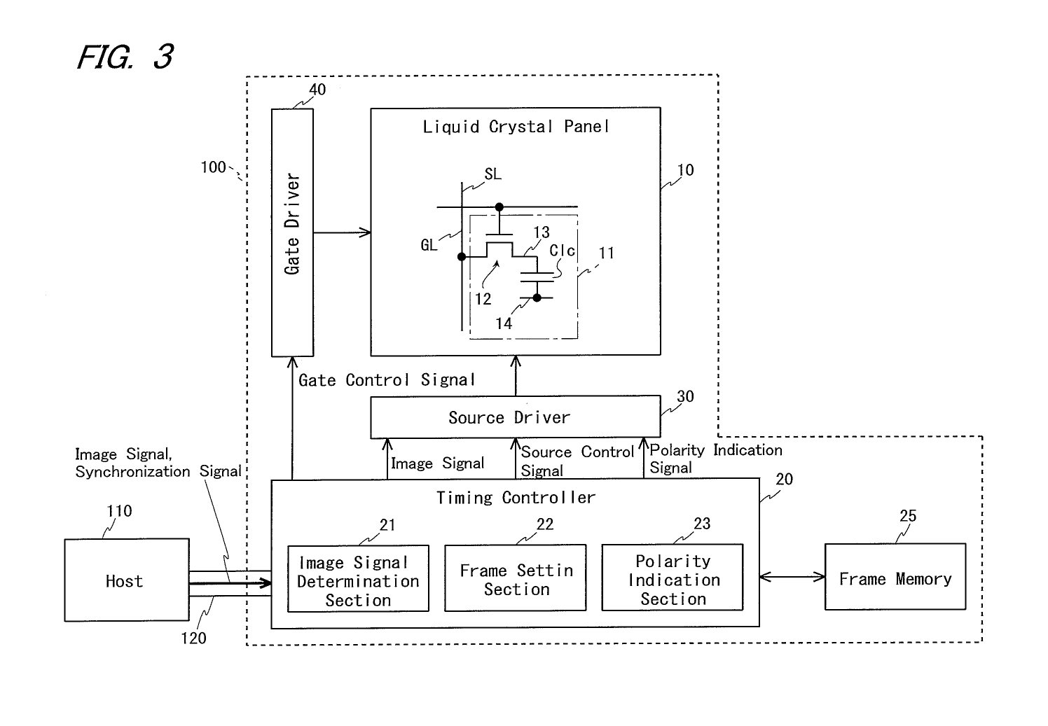

FIG. 3 is a block diagram for describing a configuration of a liquid crystal display device 100 according to an embodiment of the present invention. The liquid crystal display device 100 includes a liquid crystal panel 10, a timing controller 20 (display controller), a frame memory 25, a source driver 30 (data-line drive circuit) and a gate driver 40 (scanning-line drive circuit). In the present embodiment, the source driver 30 and the gate driver 40 constitute the driving section. One or both of the source driver 30 and the gate driver 40 may be formed integrally with the liquid crystal panel 10. Outside the liquid crystal display device 100, there is a host 110 which is constituted primarily by a central Processing unit (CPU).

The liquid crystal panel 10 is formed with a plurality of data lines SL, a plurality of scanning lines GL and a plurality of pixel formation portions 11 arranged correspondingly to intersections made by the data lines SL and the scanning lines GL. FIG. 3 shows only one data line SL, one scanning line GL and one pixel formation portion 11 for description. The pixel formation portion 11 includes: a thin film transistor (TFT) 12 which has its gate terminal (control terminal) connected to a scanning line GL that passes through a corresponding one of the intersections, and has its source terminal (first conduction terminal) connected to a data line SL that passes through the corresponding intersection; a pixel electrode 13 which is connected to a drain terminal (second conduction terminal) of the TFT 12; a common electrode 14 which is provided commonly to all of the pixel formation portions 11; and a liquid crystal layer which is sandwiched between the pixel electrode 13 and the common electrode 14 and is common to the pixel formation portions 11. The pixel electrode 13 and the common electrode 14 form a liquid crystal capacitance Clc, which constitutes a pixel capacitance. Often, there is provided an auxiliary capacitance in parallel with the liquid crystal capacitance Clc for reliable voltage holding in the pixel capacitance; however, for the sake of descriptive convenience, the present DESCRIPTION assumes that the pixel capacitance is made only of the liquid crystal capacitance Clc. When the TFT 12 is in its ON state, a data voltage which is sent via the data lines SL is written to the liquid crystal capacitance Clc. The other terminal of the liquid crystal capacitance Clc, i.e., the common electrode 14, is supplied with a common voltage which comes through an unillustrated common electrode driver. As described, the liquid crystal capacitance Clc holds a voltage, i.e., a liquid crystal application voltage, which is determined by the data voltage and the common voltage.

The TFT 12 functions as a switching element which assumes an ON state to allow writing of the data voltage to the liquid crystal capacitance Clc, and an OFF state to keep holding the written data voltage. The TFT 12 may be provided, for example, by an oxide TFT which has its channel layer formed of an oxide semiconductor. Particularly suitable among many oxide TFTs is a TFT whose channel layer is formed of In—Ga—Zn—O oxide, i.e., an oxide semiconductor containing indium (In), gallium (Ga), zinc (Zn), and oxygen (O) as primary ingredients. TFTs having an In—Ga—Zn—O channel layer feature a significantly smaller off-leak current than silicon TFTs which use, e.g., amorphous silicon to form their channel layer, so the liquid crystal application voltage does not change significantly during the OFF time. Examples of other oxide TFTs than those whose channel layer is formed of In—Ga—Zn—O are those whose channel layer is formed of an oxide semiconductor containing at least one of indium, gallium, zinc, copper (Cu), silicon (Si), tin (Sn), aluminum (Al), calcium (Ca), germanium (Ge), and lead (Pb), which will provide a comparable advantage.

The host 110 gives an image signal and a synchronization signal to the timing controller 20 via an interface 120. The image signal represents an image which is to be displayed in the liquid crystal panel 10. The synchronization signal contains, for example, a horizontal synchronization signal and a vertical synchronization signal. The synchronization signal also contains information which indicates a frame configuration for the drive period and a frame configuration for the intermission period. The host 110 in the present embodiment supplies the image signal and the synchronization signal to the timing controller 20 in all frames.

The timing controller 20 controls the source driver 30 and the gate driver 40 based on the image signal and the synchronization signal received from the host 110 to perform an intermission driving, in which a drive period and a intermission period are alternately repeated, by way of a polarity inversion drive method. The polarity inversion drive method employed here may be whichever of dot-inversion driving method, line inversion drive method, column inversion drive method and frame inversion drive method. The timing controller 20 gives, more specifically, an image signal, a source control signal and a polarity indication signal to the source driver 30, whereas it gives a gate control signal to the gate driver 40. The source control signal contains, for example, a source start pulse signal, a source latch strobe signal and a source clock signal. The gate control signal contains, for example, a gate start pulse signal, a gate clock signal and a gate output enabling signal. The polarity indication signal is a signal for determining the data voltage polarity. The timing controller 20 makes the source driver 30 and the gate driver 40 respectively drive the data lines SL and the scanning lines GL in a refreshing frame, while making the source driver 30 and the gate driver 40 respectively stop driving of the data lines SL and scanning lines GL in a non-refreshing frame.

The timing controller 20 includes, more specifically, an image signal determination section 21, a frame setting section 22 and a polarity indication section 23. The image signal determination section 21 determines whether or not a frame image signal and a previous frame image signal are identical with each other. The frame setting section 22 makes frame setting for the drive period and the intermission period. The frame setting section 22 is designed to be capable of determining the number of refreshing frames included in the drive period. Alternatively, the frame setting section 22 may be designed to store information, which is contained in the synchronization signal and indicates frame configuration for the drive period and the frame configuration for the intermission period, in an unillustrated register. The source control signal and the gate control signal are generated in accordance with processes performed by the image signal determination section 21 and the frame setting section 22, depending upon whether the frame in process is a refreshing frame or a non-refreshing frame. The polarity indication section 23 generates the polarity indication signal typically for every refreshing frame, following the frame setting made by the frame setting section 22. The polarity indication section 23 operates differently depending on whether the number of refreshing frames included in the drive period is an even number or an odd number (details will be described later). It should be noted here that the determiner of the number of refreshing frames included in the drive period need not necessarily be the frame setting section 22; it may be the polarity indication section 23, or may be an unillustrated external constituent element outside of the timing controller 20. It should also be noted here that each constituent element which is included in the timing controller 20 is implemented as a piece of hardware; however, it may be implemented by way of software.

The frame memory 25 is provided by a volatile memory such as a DRAM (Dynamic Random Access Memory). The frame memory 25 at least has a memory area for storing a frameful of image signals. The timing controller 20 writes the image signal received from the host 110, to the frame memory 25. Also, the timing controller 20 reads the image signal from the frame memory 25 and gives it to the source driver 30 when the frame needs the image signal stored in the frame memory 25.

The source driver 30 generates the data voltage based on the image signal, the source control signal and the polarity indication signal received from the timing controller 20 and gives the data voltage to the data lines SL, in the refreshing frame. The gate driver 40 selects the scanning lines GL sequentially based on the gate control signal from the timing controller 20, in the refreshing frame. The data voltage is written to the pixel formation portion 11 which is connected to the selected one of the scanning lines GL. In this way, a data voltage is written to each pixel formation portion 11, whereby a screen refreshing is performed. In the non-refreshing frame, data voltage writing is not performed, so a screen refreshing does not take place.

<1.2 Intermission Driving>

In the present embodiment, there are two types of drive periods, i.e., a drive period to perform a refreshing for an image updating (hereinafter called “first drive period”) and a drive period to perform a periodical refreshing during the time when the image is not updated (hereinafter called “second drive period”). The second drive period is for eliminating bias in the liquid crystal application voltage polarity. In cases where the TFT 12 is provided by a non-oxide TFT, i.e., if the TFT 12 is provided by one which has a relatively large off-leak current, the second drive period also provides an advantage of restoring the liquid crystal application voltage to an original value from a value affected by the off-leak current of the TFT 12. This makes it possible to maintain display quality. Even in the present embodiment where the TFT 12 is provided by an oxide TFT, a slight off-leak current is unavoidable and therefore, the same quality maintaining effect is obtained to some degree.

In the present embodiment, it is assumed that the first and the second drive periods have the same number of refreshing frames, and each drive period is followed by an intermission period which is made of four non-refreshing frames (except for cases where there is an image updating).

<1.2.1 Even Number of Refreshing Frames>

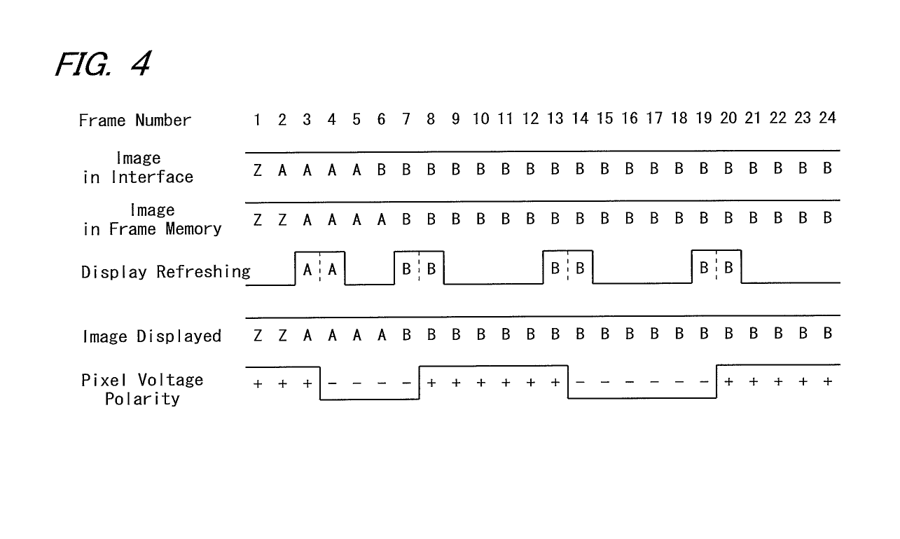

FIG. 4 is a timing chart which shows control details in each frame in the present embodiment, for cases where each drive period has an even number (two, in this particular case) of refreshing frames. In this case, the polarity indication section 23 gives the source driver 30 a polarity indication signal which will make a data voltage to be written to the pixel formation portion 11 in the first refreshing frame in each drive period have the same polarity as of a data voltage written to the pixel formation portion 11 in a refreshing frame immediately preceding said first refreshing frame. It should be noted here that the number of refreshing frames in each drive period can be changed by means of the synchronization signal from the host 110 for example. In the frame immediately preceding the first frame, it is assumed that an image “Z” is displayed in the liquid crystal panel 10. Also, an image signal which represents the image “Z” is stored in the frame memory 25. The liquid crystal application voltage has a positive polarity (+), and the first and the second frames are non-refreshing frames.

In the first frame, the host 110 gives the timing controller 20 an image signal which represents the image “Z”, via the interface 120. In the first frame, the image signal determination section 21 determines whether or not the image signal received by the timing controller 20 and the image signal stored in the frame memory 25 are identical with each other. As assumed above, the frame memory 25 stores an image signal which represents the image “Z” in the first frame. Therefore, the image signal determination section 21 determines that the two signals are identical with each other in the first frame. Following the determination result, the timing controller 20 does not write the image signal received from the host 110, to the frame memory 25. Since the first frame is a non-refreshing frame as assumed above, the timing controller 20 controls the source driver 30 and the gate driver 40 not to drive the liquid crystal panel 10. More specifically, the timing controller 20 gives the source driver 30 a source control signal which instructs that the data lines SL should not be driven, whereas the controller does not give the source driver 30 an image signal nor a polarity indication signal. Also, the timing controller 20 gives the gate driver 40 agate control signal which instructs that the scanning lines GL should not be driven. In this way, a display refreshing is not performed in the liquid crystal panel. In the first frame, the same liquid crystal application voltage (positive polarity) as in the immediately preceding frame is maintained. Therefore, the first frame maintains the display of the image “Z”.

In the second frame, the host 110 gives the timing controller 20 an image signal which represents an image “A”, via the interface 120. In the second frame, the image signal determination section 21 determines whether or not the image signal received by the timing controller 20 and the image signal stored in the frame memory 25 are identical with each other. As a result, the image signal determination section 21 determines that the two signals are not identical in the second frame. Following the determination result, the timing controller 20 writes the image signal, which is received from the host 110 and represents the image “A”, to the frame memory 25. Thus, the frame memory 25 stores the image signal which represents the image “A”. The frame setting section 22 sets the third and the fourth frames as a first drive period. Since the second frame is a non-refreshing frame, the same liquid crystal application voltage (positive polarity) as in the first frame is maintained. Therefore, the second frame maintains the display of the image “Z”.

In the third frame, the host 110 gives the timing controller 20 an image signal which represents the image “A”, via the interface 120. Since the image signal received by the timing controller 20 and the image signal stored in the frame memory 25 are identical with each other, the image signal received from the host 110 is not written to the frame memory 25. Since the third frame is a refreshing frame, the timing controller 20 gives the source driver 30 a source control signal which instructs that the data lines SL should be driven. The controller also gives the source driver 30 the image signal which is read from the frame memory, and a polarity indication signal. Also, the timing controller 20 gives the gate driver 40 a gate control signal which instructs that the scanning lines GL should be driven. In this way, a display refreshing in the liquid crystal panel is performed in the third frame, and the image “A” is displayed. Since the first drive period includes an even number of refreshing frames and the third frame is the first refreshing frame included in the first drive period, the polarity indication section 23 gives the source driver 30 a polarity indication signal which indicates a positive polarity so that a data voltage to be written to the pixel formation portion 11 in the third frame has the same polarity as of a data voltage written to the pixel formation portion 11 in the immediately preceding refreshing frame (prior to the first frame). Therefore, the liquid crystal application voltage polarity in the third frame becomes positive, i.e., the same polarity as in the second frame.

In the fourth frame, the host 110 gives the timing controller 20 an image signal which represents the image “A”, via the interface 120. Since the image signal received by the timing controller 20 and the image signal stored in the frame memory 25 are identical with each other, the image signal received from the host 110 is not written to the frame memory 25. In the fourth frame, which is a refreshing frame like the third frame, a display refreshing is performed by using the image signal which is read from the frame memory 25 and represents the image “A”. Therefore the image “A” is displayed like in the third frame. However, in the fourth frame, the polarity indication section 23 gives the source driver 30 a polarity indication signal which indicates a negative polarity so that the data voltage polarity is inverted for each refreshing frame during the first drive period. Therefore, the liquid crystal application voltage polarity in the fourth frame becomes negative, due to the polarity inversion from the third frame. The frame setting section 22 sets the four frames which follow the fifth frame for an intermission period (but the period is aborted if an image updating is to take place).

In the fifth frame, the host 110 gives the timing controller 20 an image signal which represents the image “A”, via the interface 120. Since the image signal received by the timing controller 20 and the image signal stored in the frame memory 25 are identical with each other, the image signal received from the host 110 is not written to the frame memory 25, like in the fourth frame. Since the fifth frame is a non-refreshing frame, the same liquid crystal application voltage (negative polarity) as in the fourth frame is maintained. Therefore, the fifth frame maintains the display of the image “A”.

In the sixth frame, the host 110 gives the timing controller 20 an image signal which represents an image “B”, via the interface 120. In the sixth frame, the image signal determination section 21 determines whether or not the image signal received by the timing controller 20 and the image signal stored in the frame memory 25 are identical with each other. As a result, the image signal determination section 21 determines that the two signals are not identical in the sixth frame. Following the determination result, the timing controller 20 writes the image signal, which is received from the host 110 and represents the image “B”, to the frame memory 25. Thus, the frame memory 25 stores the image signal which represents the image “B”. The frame setting section 22 aborts the intermission period and sets the seventh and the eighth frames as a first drive period. Since the sixth frame is a non-refreshing frame, the same liquid crystal application voltage (negative polarity) as in the fifth frame is maintained. Therefore, the fifth frame maintains the display of the image “A”.

In the seventh frame, the host 110 gives the timing controller 20 an image signal which represents the image “B”, via the interface 120. Since the image signal received by the timing controller 20 and the image signal stored in the frame memory 25 are identical with each other, the image signal received from the host 110 is not written to the frame memory 25. Since the seventh frame is a refreshing frame, a display refreshing is performed by using the image signal which is read from the frame memory 25 and represents the image “B”. In this way, a display refreshing in the liquid crystal panel is performed in the seventh frame, and the image “B” is displayed. Since the first drive period includes an even number of refreshing frames and the seventh frame is the first refreshing frame included in the first drive period, the polarity indication section 23 gives the source driver 30 a polarity indication signal which indicates a negative polarity so that a data voltage to be written to the pixel formation portion 11 in the seventh frame will have the same polarity as of the data voltage written to the pixel formation portion 11 in the immediately preceding refreshing frame (the fourth frame). Therefore, the liquid crystal application voltage polarity in the seventh frame becomes negative, i.e., the same as in the sixth frame.

In the eighth frame, the host 110 gives the timing controller 20 an image signal which represents the image “B”, via the interface 120. Since the image signal received by the timing controller 20 and the image signal stored in the frame memory 25 are identical with each other, the image signal received from the host 110 is not written to the frame memory 25. In the eighth frame, which is a refreshing frame like the seventh frame, a display refreshing is performed by using the image signal which is read from the frame memory 25 and represents the image “B”. Therefore the image “B” is displayed like in the seventh frame. However, in the eighth frame, the polarity indication section 23 gives the source driver 30 a polarity indication signal which indicates a positive polarity so that the data voltage polarity will be inverted for each refreshing frame during the first drive period. Therefore, the liquid crystal application voltage polarity in the eighth frame becomes positive, due to the polarity inversion from the seventh frame. The frame setting section 22 sets the ninth through the twelfth frames as an intermission period.

In the ninth through the twelfth frames, the host 110 gives the timing controller 20 an image signal which represents the image “B”, via the interface 120. Since the image signal received by the timing controller 20 and the image signal stored in the frame memory 25 are identical with each other, the image signal received from the host 110 is not written to the frame memory 25. Since each of the ninth through the twelfth frames is a non-refreshing frame, the same liquid crystal application voltage (positive polarity) as in the eighth frame is maintained. Therefore, the ninth through the twelfth frames maintain the image “B”. The frame setting section 22 sets the thirteenth and the fourteenth frames as a second drive period.

In the thirteenth frame, the host 110 gives the timing controller 20 an image signal which represents the image “B”, via the interface 120. Since the image signal received by the timing controller 20 and the image signal stored in the frame memory 25 are identical with each other, the image signal received from the host 110 is not written to the frame memory 25. Since the thirteenth frame is a refreshing frame, a display refreshing is performed by using the image signal which is read from the frame memory 25 and represents the image “B”. In this way, a data voltage which represents the image “B” is written again and the image “B” is displayed. Since the second drive period includes an even number of refreshing frames, the polarity indication section 23 gives the source driver 30 a polarity indication signal which indicates a positive polarity so that the data voltage to be written to the pixel formation portion 11 in the thirteenth frame will have the same polarity as of the data voltage written to the pixel formation portion 11 in the immediately preceding refreshing frame (the eighth frame). Therefore, the liquid crystal application voltage polarity in the thirteenth frame becomes the same as in the twelfth frame.

In the fourteenth frame, the host 110 gives the timing controller 20 an image signal which represents the image “B”, via the interface 120. Since the image signal received by the timing controller 20 and the image signal stored in the frame memory 25 are identical with each other, the image signal received from the host 110 is not written to the frame memory 25. In the fourteenth frame, which is a refreshing frame like the thirteenth frame, a display refreshing is performed by using the image signal which is read from the frame memory 25 and represents the image “B”. Therefore the image “B” is displayed like in the thirteenth frame. However, in the fourteenth frame, the polarity indication section 23 gives the source driver 30 a polarity indication signal which indicates a negative polarity so that the data voltage polarity is inverted for each refreshing frame during the second drive period. Therefore, the liquid crystal application voltage polarity in the fourteenth frame becomes negative, due to the polarity inversion from the thirteenth frame. The frame setting section 22 sets the fifteenth through the eighteenth frames as an intermission period.

In the fifteenth through the eighteenth frame, the same control is performed as in the ninth through the twelfth frames respectively, except that the liquid crystal application voltage polarity is inverted (the fifteenth through the eighteenth frames are negative-polarity frames). Therefore, no more details will be given here. The frame setting section 22 sets the nineteenth through the twentieth frames as a second drive period.

In the nineteenth and the twentieth frames, the same control is performed as in the thirteenth and the fourteenth frame respectively, except that the liquid crystal application voltage polarity is inverted (nineteenth and the twentieth frames are a negative-polarity frame and a positive-polarity frame respectively). Therefore, no more details will be described here. The frame setting section 22 sets the twenty-first through the twenty-fourth frames as an intermission period.

In the twenty-first through the twenty-fourth frames, the same control as in the ninth through the twelfth frames is provided respectively, so no more details will be described here.

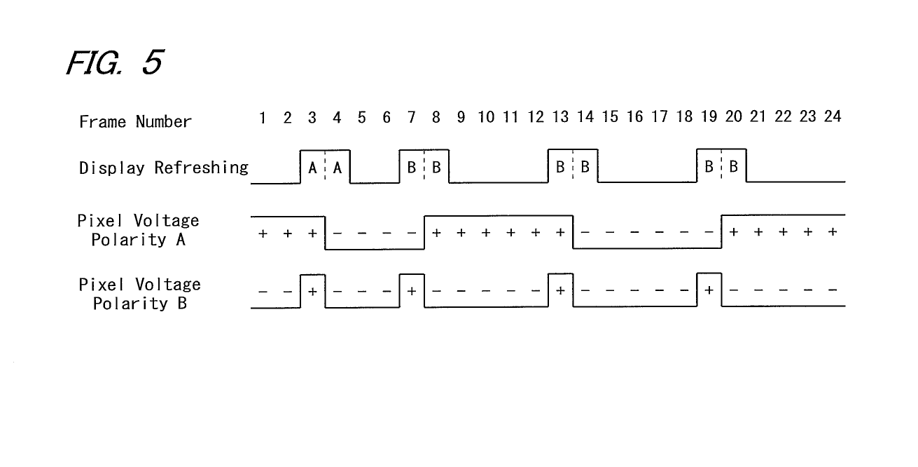

FIG. 5 is a timing chart for comparison between the intermission driving according to the present embodiment for cases where each drive period has an even number of refreshing frames, and the second example of intermission driving which was discussed in the basic consideration. FIG. 5 uses a term “pixel voltage polarity A”, which indicates pixel voltage polarities in the intermission driving according to the present embodiment shown in FIG. 4. FIG. 5 also uses a term “pixel voltage polarity B”, which indicates pixel voltage polarities in the case where the polarity inversion operation used in the second example of intermission driving discussed in the basic consideration with FIG. 2 is applied to the display refreshing in FIG. 4. An attention from a point when the first, first drive period is started to a point when the intermission period after the second, second drive period is ended (the third through the twenty-fourth frames) reveals that the second example of intermission driving in the basic consideration includes four positive-polarity frames and eighteen negative-polarity frames, whereas the present embodiment includes twelve positive-polarity frames and ten negative-polarity frames. As exemplified, even in cases where the drive period includes an even number of refreshing frames, the present embodiment makes the number of positive-polarity frames and the number of negative-polarity frames more balanced with each other than the second example of intermission driving in the basic consideration.

<1.2.2 Odd Number of Refreshing Frames>

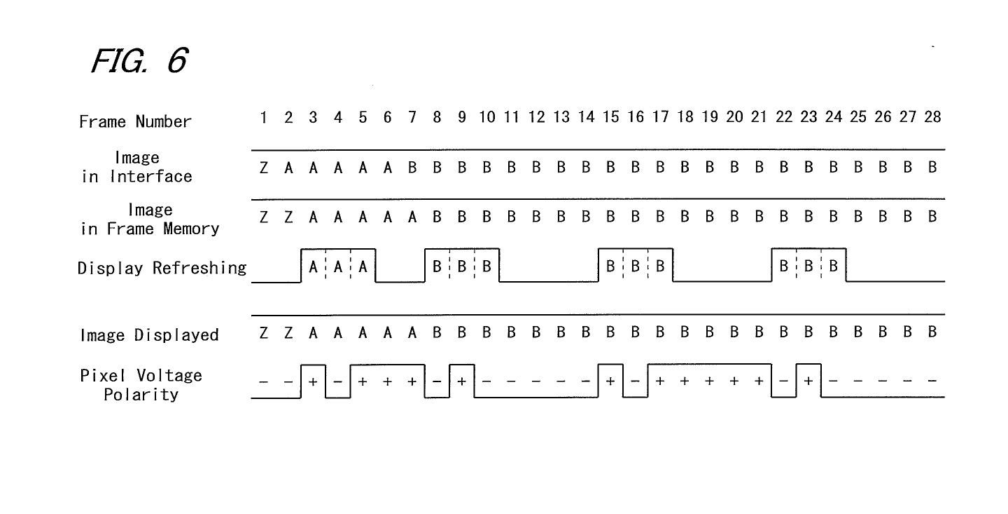

FIG. 6 is a timing chart which shows control details in each frame in the present embodiment, for cases where each drive period has an odd number (three, in this particular case) of refreshing frames. In this case, the polarity indication section 23 gives the source driver 30 a polarity indication signal which will make a data voltage to be written to the pixel formation portion 11 in each refreshing frame in each drive period have a different polarity from that of a data voltage written to the pixel formation portion 11 in a refreshing frame immediately preceding each relevant refreshing frame. In the first and the second frames the same control is performed as in the example shown in FIG. 4 except that the liquid crystal application voltage polarity is negative, so no more description will be given here. The frame setting section 22 sets the third through the fifth frames as a first drive period.

In the third frame, the host 110 gives the timing controller 20 an image signal which represents the image “A”, via the interface 120. Since the image signal received by the timing controller 20 and the image signal stored in the frame memory 25 are identical with each other, the image signal received from the host 110 is not written to the frame memory 25. Since the third frame is a refreshing frame, a display refreshing is performed by using the image signal which is read from the frame memory 25 and represents the image “A”, and so the image “A” is displayed. Since the first drive period includes an odd number of refreshing frames, the polarity indication section 23 gives the source driver 30 a polarity indication signal which indicates a positive polarity so that a data voltage to be written to the pixel formation portion 11 in the third frame has an inverted polarity from that of a data voltage written to the pixel formation portion 11 in the immediately preceding refreshing frame (before the first frame). Therefore, the liquid crystal application voltage polarity in the third frame becomes positive, changing from the polarity in the second frame.

In the fourth frame, the host 110 gives the timing controller 20 an image signal which represents the image “A”, via the interface 120. Since the image signal received by the timing controller 20 and the image signal stored in the frame memory 25 are identical with each other, the image signal received from the host 110 is not written to the frame memory 25. In the fourth frame, which is a refreshing frame like the third frame, a display refreshing is performed by using the image signal which is read from the frame memory 25 and represents the image “A”. Therefore the image “A” is displayed like in the third frame. The polarity indication section 23 gives the source driver 30 a polarity indication signal which indicates a negative polarity so that the polarity of a data voltage to be written to the pixel formation portion 11 in the fourth frame is inverted from the polarity of the data voltage written to the pixel formation portion 11 in the immediately preceding refreshing frame (the third frame). Therefore, the liquid crystal application voltage polarity in the fourth frame becomes negative, changing from the polarity in the third frame.

In the fifth frame, the host 110 gives the timing controller 20 an image signal which represents the image “A”, via the interface 120. Since the image signal received by the timing controller 20 and the image signal stored in the frame memory 25 are identical with each other, the image signal received from the host 110 is not written to the frame memory 25. In the fifth frame, which is a refreshing frame like the fourth frame, a display refreshing is performed by using the image signal which is read from the frame memory 25 and represents the image “A”. Therefore the image “A” is displayed like in the fourth frame. The polarity indication section 23 gives the source driver 30 a polarity indication signal which indicates a positive polarity so that the polarity of a data voltage to be written to the pixel formation portion 11 in the fifth frame is inverted from the polarity of the data voltage written to the pixel formation portion 11 in the immediately preceding refreshing frame (the fourth frame). Therefore, the liquid crystal application voltage polarity in the fifth becomes positive, changing from the polarity in the fourth frame. The frame setting section 22 sets the sixth through the ninth frames as an intermission period (but the period will be aborted if an image updating is to take place).

In the sixth and the seventh frames, the same control is performed as in the example shown in FIG. 4 except that the liquid crystal application voltage polarity is inverted (the sixth and the seventh frames are positive-polarity frames), so no more description will be given here. Since an image updating is performed in the seventh frame, the frame setting section 22 sets the eighth through the tenth frames as a first drive period.

In the eighth through the tenth frames, the same control is performed as in the third through the fifth frames respectively, except that the image signal represents the image “B” and the liquid crystal application voltage polarity is inverted (the eighth through the tenth frames are a negative-polarity frame, a positive-polarity frame and a negative-polarity frame respectively). Therefore, no more details will be described here. The frame setting section 22 sets the eleventh through the fourteenth frames as an intermission period.

In the eleventh through the fourteenth frames, the host 110 gives the timing controller 20 an image signal which represents an image “B”, via the interface 120. Since the image signal received by the timing controller 20 and the image signal stored in the frame memory 25 are identical with each other, the image signal received from the host 110 is not written to the frame memory 25. Since each of the eleventh through the fourteenth frames is a non-refreshing frame, the same liquid crystal application voltage (negative polarity) as in the tenth frame is maintained. Therefore, the eleventh through the fourteenth frames maintain the image “B”. The frame setting section 22 sets the fifteenth through the seventeenth frames as a second drive period.

In the fifteenth frame, the host 110 gives the timing controller 20 an image signal which represents the image “B”, via the interface 120. Since the image signal received by the timing controller 20 and the image signal stored in the frame memory 25 are identical with each other, the image signal received from the host 110 is not written to the frame memory 25. Since the fifteenth frame is a refreshing frame, a display refreshing is performed by using the image signal which is read from the frame memory 25 and represents the image “B”. In this way, a data voltage which represents the image “B” is written again and the image “B” is displayed. Since the second drive period includes an odd number of refreshing frames, the polarity indication section 23 gives the source driver 30 a polarity indication signal which indicates a positive polarity so that the data voltage to be written to the pixel formation portion 11 in the fifteenth frame has an inverted polarity from that of the data voltage written to the pixel formation portion 11 in the immediately preceding refreshing frame (the tenth frame). Therefore, the liquid crystal application voltage polarity in the fifteenth frame becomes positive, changing from the polarity in the fourteenth frame.

In the sixteenth frame, the host 110 gives the timing controller 20 an image signal which represents the image “B”, via the interface 120. Since the image signal received by the timing controller 20 and the image signal stored in the frame memory 25 are identical with each other, the image signal received from the host 110 is not written to the frame memory 25. In the sixteenth frame, which is a refreshing frame like the fifteenth frame, a display refreshing is performed by using the image signal which is read from the frame memory 25 and represents the image “B”. Therefore the image “B” is displayed like in the fifteenth frame. The polarity indication section 23 gives the source driver 30 a polarity indication signal which indicates a negative polarity so that the polarity of a data voltage to be written to the pixel formation portion 11 in the sixteenth frame is inverted from the polarity of the data voltage written to the pixel formation portion 11 in the immediately preceding refreshing frame (the fifteenth frame). Therefore, the liquid crystal application voltage polarity in the sixteenth frame becomes negative, changing from the polarity in the fifteenth frame.

In the seventeenth frame, the host 110 gives the timing controller 20 an image signal which represents the image “B”, via the interface 120. Since the image signal received by the timing controller 20 and the image signal stored in the frame memory 25 are identical with each other, the image signal received from the host 110 is not written to the frame memory 25. In the seventeenth frame, which is a refreshing frame like the sixteenth frame, a display refreshing is performed by using the image signal which is read from the frame memory 25 and represents the image “B”. Therefore, the image “B” is displayed like in the sixteenth frame. The polarity indication section 23 gives the source driver 30 a polarity indication signal which indicates a positive polarity so that the polarity of a data voltage to be written to the pixel formation portion 11 in the seventeenth frame is inverted from the polarity of the data voltage written to the pixel formation portion 11 in the immediately preceding refreshing frame (the sixteenth frame). Therefore, the liquid crystal application voltage polarity in the seventeenth frame becomes positive, changing from the polarity in the sixteenth frame. The frame setting section 22 sets the eighteenth through the twenty-first frames as an intermission period.

In the eighteenth through the twenty-first frames, the same control is performed as in the eleventh through the fourteenth frames respectively, except that the liquid crystal application voltage polarity is inverted (the eighteenth through the twenty-first frames are positive-polarity frames). Therefore, no more details will be given here. The frame setting section 22 sets the twenty-second through the twenty-fourth frames as a second drive period.

In the twenty-second through the twenty-fourth frames, the same control is performed as in the fifteenth through the seventeenth frames respectively, except that the liquid crystal application voltage polarity is inverted (the twenty-second through the twenty-fourth frames are a negative-polarity frame, a positive-polarity frame and a negative-polarity frame respectively). Therefore, no more details will be given here. The frame setting section 22 sets the twenty-fifth through the twenty-eighth frames as an intermission period.

In the twenty-fifth through the twenty-eighth frames, the same control as in the eleventh through the fourteenth frames is provided respectively, so no more details will be described here.

An attention to a period covering from a point when the first, first drive period is started to a point when the intermission period after the second, second drive period is ended (the third through the twenty-eighth frames) reveals that there are twelve positive-polarity frames and fourteen negative-polarity frames. As exemplified, the number of positive-polarity frames and the number of negative-polarity frames are also balanced with each other when the drive period includes an odd number of refreshing frames. It should be noted here that in the present embodiment, the intermission driving in the case where each drive period includes an odd number of refreshing frames performs the same kinds of polarity inversion as seen in the intermission driving shown in FIG. 1 which was discussed earlier in the basic consideration.

<1.3 Advantages>

According to the present embodiment, when the first and the second drive periods each include an even number of refreshing frames, a data voltage to be written to the pixel formation portion 11 in the first refreshing frame included in the drive period has the same polarity as of a data voltage written to the pixel formation portion 11 in the immediately preceding refreshing frame. This ensures that even if the data voltage polarity is inverted for each refreshing frame during the drive period, two consecutive intermission periods which sandwich the drive period have different liquid crystal application voltage polarities from each other. The arrangement ensures that the number of positive-polarity frames and the number of negative-polarity frames become approximately equal to each other, thereby removing bias in the liquid crystal application voltage polarity. Therefore, it is possible to reduce power consumption while preventing deterioration of the liquid crystal.

Also, according to the present embodiment, when the first and the second drive periods each include an odd number of refreshing frames, two consecutive intermission periods which sandwich the drive period have different polarities from each other in their respective constituent frames. The arrangement ensures that the number of positive-polarity frames and the number of negative-polarity frames become approximately equal to each other, thereby removing bias in the liquid crystal application voltage polarity. Therefore, it is possible to reduce power consumption while preventing deterioration of the liquid crystal also in the case where the drive period includes an odd number of refreshing frames.

According to the present embodiment, an image updating is accompanied by a plurality (even number) of refreshing frames. This prevents the displayed image from persisting as a residual image.

Also, according to the present embodiment, the TFT 12 is provided by an oxide TFT such as one having its channel layer formed of In—Ga—Zn—O. Since oxide TFTs feature a very small off-leak current, the liquid crystal application voltage does not change significantly while the TFT is turned OFF. This makes it possible to make the intermission period longer for further decrease in power consumption.

<1.4 Variations>

<1.4.1 First Variation>

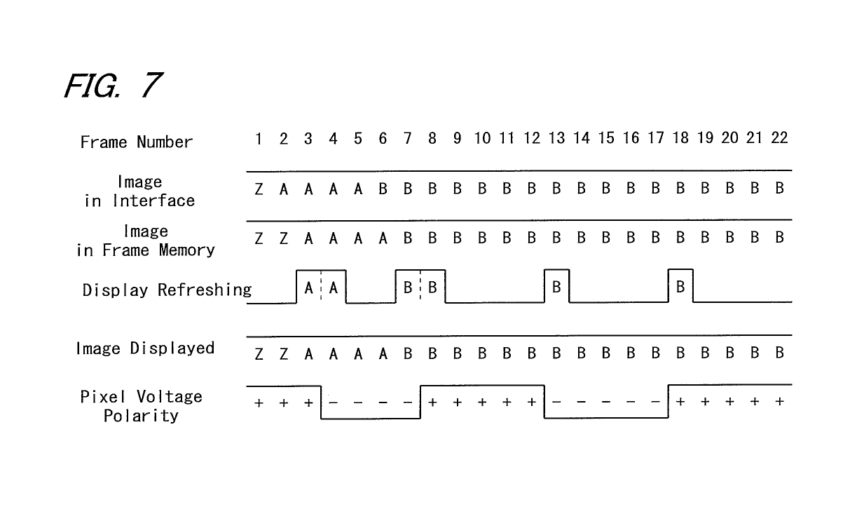

FIG. 7 is a timing chart which shows control details in each frame in a first variation of the embodiment described thus far. In the present variation, a first drive period includes an even number (two, in this specific example) of refreshing frames, whereas a second drive period includes an odd number (one, in this specific example) of refreshing frame. The third and the fourth frame constitute a first drive period, the seventh and the eighth frame constitute a first drive period, the thirteenth frame is a second drive period and the fourteenth frame is a second drive period. An attention to a period covering from a point when the first, first drive period is started to a point when the intermission period after the second, second drive period is ended (the third through the twenty-second frames) reveals that there are eleven positive-polarity frames and nine negative-polarity frames; in other words, the number of positive-polarity frames and the number of negative-polarity frames are relatively well balanced. In this way, the variation provides the same advantages as does the embodiment described first.

<1.4.2 Second Variation>

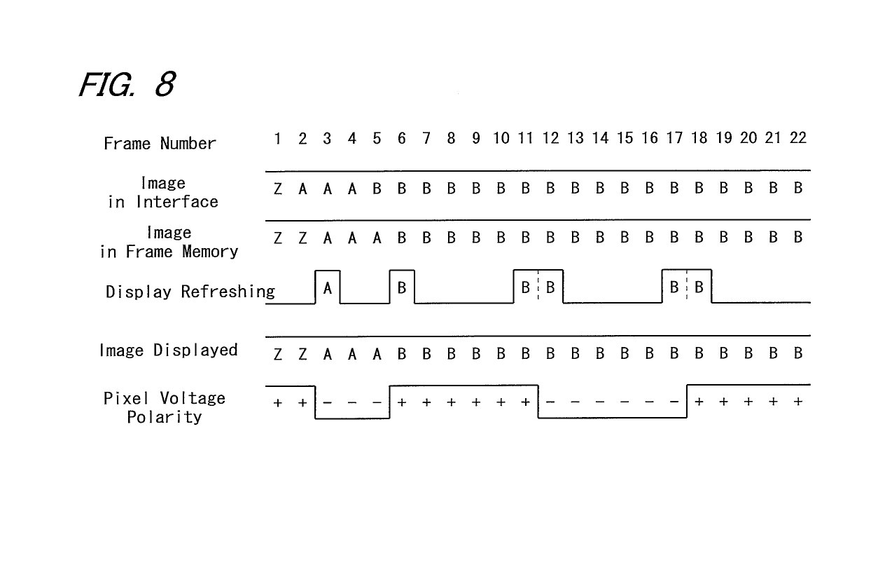

FIG. 8 is a timing chart which shows control details in each frame in a second variation of the embodiment described thus far. In the present variation, a first drive period includes an odd number (one, in this specific example) of refreshing frame, whereas a second drive period includes an even number (two, in this specific example) of refreshing frame. The third frame is a first drive period, the sixth frame is a first drive period, the eleventh and the twelfth frames constitute a second drive period and the seventeenth and the eighteenth frames constitute a second drive period. An attention to a period covering from a point when the first, first drive period is started to a point when the intermission period after the second, second drive period is ended (the third through the twenty-second frames) reveals that there are eleven positive-polarity frames and nine negative-polarity frames; in other words, the number of positive-polarity frames and the number of negative-polarity frames are relatively well balanced. In this way, the variation provides the same advantages as does the embodiment described first.

<1.4.3 Third Variation>

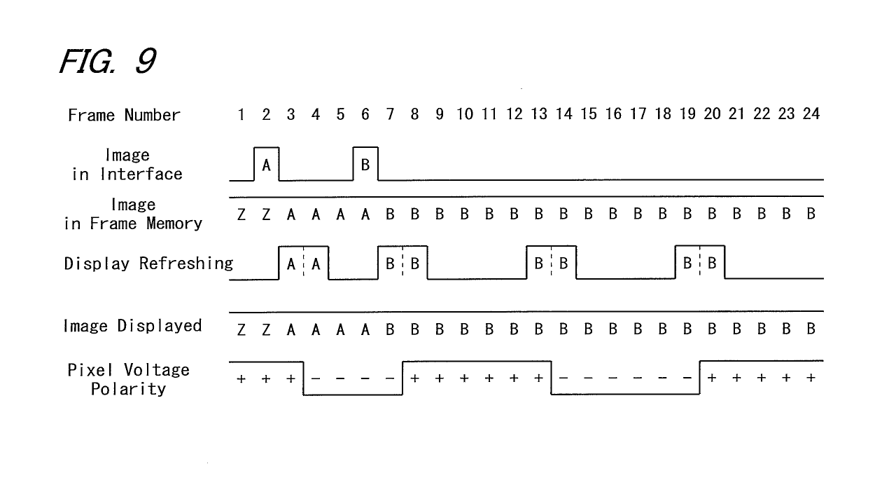

FIG. 9 is a timing chart which shows control details in each frame in a third variation of the embodiment described thus far. The present variation differs from the embodiment in that the host 110 sends an image signal only when there is an image updating to be performed. Therefore, the arrangement does not require the image signal determination section 21 in the timing controller 20. In each frame, the host 110 determines whether or not an image signal in the current frame is identical with the image signal in the immediately preceding frame. Upon determination that the two are not identical with each other, the host 110 gives the new image signal to the timing controller 20 via the interface 120 (the second and the sixth frames), whereas if the two are identical, the image signal is not given to the timing controller 20 (the first, the third through the fifth, and the seventh through the twenty-fourth frames). According to the present variation, it is not necessary to have the image signal determination section 21 inside the timing controller 20. Once the timing controller 20 receives the image signal from the host 110, it writes the image signal to the frame memory 25. The present variation reduces the number of transmissions of image signals from the host 110 to the timing controller 20. Therefore, the variation decreases power consumption in the interface 120.

<1.4.4 Fourth Variation>

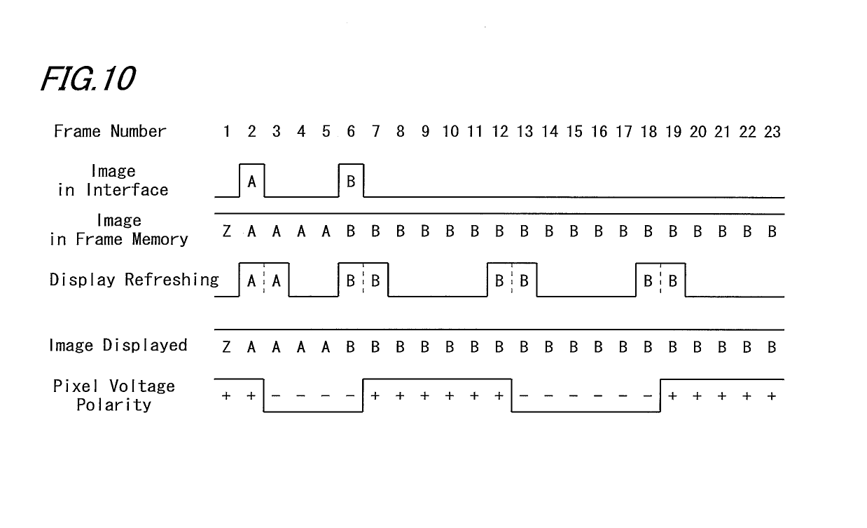

FIG. 10 is a timing chart which shows control details in each frame in a fourth variation of the embodiment described thus far. Like the third variation, the host 110 in the present variation sends an image signal only when there is an image updating to be performed. However, the present variation differs from any of the above-described embodiment and variations in that the display refreshing is performed right in that frame when the timing controller 20 receives the image signal. In this process, the timing controller 20 gives the source driver 30 the image signal received from the host 110, not an image signal which is stored in the frame memory 25. For example, in the second frame, the host 110 gives the timing controller 20 an image signal which represents an image “A”, via the interface 120. Then, the timing controller 20 gives this image signal, which is just received from the host 110 and represents the image “A”, to the source driver 30 within the second frame. The timing controller 20 also writes the image signal, which is received from the host 110 and represents the image “A”, to the frame memory 25. Thus, the frame memory 25 stores the image signal which represents the image “A”. The present variation decreases the number of times of accessing the frame memory 25 in the first drive period. Therefore, the variation decreases power consumption used for making access to the frame memory 25.

<1.4.5 Other Variations>

The present invention is not limited to the embodiment described above or to any of the first through the fourth variations thereof. The invention may be varied in many ways within the spirit of the present invention. For example, the frame which constitutes each of the drive period and the intermission period in the embodiment is only to show an example, and is not limited to any of the examples covered in the present DESCRIPTION. As another variation, when there is an image updating in the embodiment, a refreshing may be made only after a predetermined intermission period is completed. Another possible variation may be made on the determination in the embodiment on whether or not two image signals are identical with each other (to see if there is an image updating). There is no limitation that the determination must be made by the use of the frame memory 25. Examples of other methods than using the frame memory 25 includes many, such as: checksum value comparison between gradation values of the image signals; histogram comparison between gradation values of the image signals; and determination based on a signal sent from the host 110. Still another variation in the embodiment may be that the image signal is always written to the frame memory 25 regardless of image updating. Also, in the embodiment, the frame memory 25 may not be employed but instead, the image signal received by the timing controller 20 from the host 110 may be used directly. Also, a non-refreshing frame(s) may be inserted between refreshing frames in the drive period.

### INDUSTRIAL APPLICABILITY

The present invention is applicable to liquid crystal display devices which perform intermission driving, and methods of driving these display devices.

### LEGENDS

10 Liquid Crystal Panel
11 Pixel formation portion
12 TFT
20 Timing Controller (Display Controller)
21 Image Signal Determination Section
22 Frame Setting Section
23 Polarity Indication Section
25 Frame Memory
30 Source Driver (Driving Section)
40 Gate Driver (Driving Section)
100 Liquid Crystal Display Device
110 Host
120 Interface

1. A liquid crystal display device comprising a plurality of pixel formation portions and performing an intermission driving of alternately repeating a drive period for writing data voltages based on an externally supplied image signal to the pixel formation portions and an intermission period for stopping writing of the data voltages to the pixel formation portions, the device further comprising:
a driving section configured to write the data voltages to the pixel formation portions, and
a display controller configured to control the driving section,
the display controller including:
a frame setting section configured to control the driving section so that the drive period includes one or more refreshing frames, which are frames for writing the data voltages to the pixel formation portions, and the intermission period includes at least one non-refreshing frame, which is a frame for stopping writing of the data voltages; and
a polarity indication section configured to control the driving section so that the data voltages to be written to the pixel formation portions in a first refreshing frame included in the drive period have a same polarity as of the data voltages written to the pixel formation portions in a refreshing frame immediately preceding the first refreshing frame and that the data voltage polarity is inverted for each refreshing frame during the drive period, if the drive period includes an even number of the refreshing frames.

2. The liquid crystal display device according to claim 1, wherein the polarity indication section controls the driving section so that the data voltages to be written to the pixel formation portions in each refreshing frame included in the drive period have a different polarity from that of the data voltages written to the pixel formation portions in a refreshing frame immediately preceding each relevant refreshing frame, if the drive period includes an odd number of the refreshing frames.

3. The liquid crystal display device according to claim 1, wherein the polarity indication section controls the driving section so that the data voltages to be written to the pixel formation portions in a first refreshing frame included in the drive period have a same polarity as of the data voltages written to the pixel formation portions in a refreshing frame immediately preceding the first refreshing frame and that the data voltage polarity is inverted for each refreshing frame during the drive period, if the drive period set for a time of image updating includes an even number of the refreshing frames.

4. The liquid crystal display device according to claim 1, further comprising data lines and scanning lines connected to the pixel formation portions and the driving section, wherein
each pixel formation portion includes:
a pixel electrode to be supplied with the data voltage; and
a thin film transistor having a control terminal connected to one of the scanning lines, a first conduction terminal connected to one of the data lines, a second conduction terminal connected to the pixel electrode, and a channel layer formed of an oxide semiconductor.

5. The liquid crystal display device according to claim 4, wherein the oxide semiconductor contains indium, gallium, zinc and oxygen as primary components.

6. A driving method for a liquid crystal display device including a plurality of pixel formation portions and performing an intermission driving of alternately repeating a drive period for writing data voltages based on an externally supplied image signal to the pixel formation portions and an intermission period for stopping writing of the data voltages to the pixel formation portions, the method comprising:
a step of controlling the driving so that the drive period includes one or more refreshing frames, which are frames for writing the data voltages to the pixel formation portions, and that the intermission period includes at least one non-refreshing frame, which is a frame for stopping writing of the data voltages; and
a step of controlling polarity of the data voltages so that the data voltages to be written to the pixel formation portions in a first refreshing frame included in the drive period have a same polarity as of the data voltages written to the pixel formation portions in a refreshing frame immediately preceding the first refreshing frame and that the data voltage polarity is inverted for each refreshing frame during the drive period, if the drive period includes an even number of the refreshing frames.
